(19) United States
(12) Patent Application Publication
(10) Pub. No.: US 2011/0138645 A1
(43) Pub. Date: Jun. 16, 2011

(54) DIGITAL DIAMETER GAUGE WITH ROTARY MOTION SENSOR AND METHOD FOR USE

(76) Inventors: YANCHEN ZHANG, San Clemente, CA (US); Meng Zhang, San Juan Capistrano, CA (US)

(21) Appl. No.: 12/967,057

(22) Filed: Dec. 14, 2010

Related U.S. Application Data
(60) Provisional application No. 61/286,777, filed on Dec. 15, 2009.

(51) Int. Cl. G01B 5/14; G01B 5/08

(52) U.S. Cl. 33/784

(57) ABSTRACT

A multiple function electronic digital measuring gauge with the following features: two measuring arms (Arm 1 and Arm 2), a rotary motion capacitive sensor unit, which include two rotary motion sensors (First Sensor and Second Sensor), an electronic processor unit, and an electronic digital display unit. First Sensor is mounted on Arm 1, and Second Sensor is mounted on Arm 2. With the movement of the two arms, the data created by the capacitive sensor unit is transferred to the electronic processor, which then computes the data into readable data and displays it on the electronic digital display unit. The reading represents the distance between the two measuring arms created by the arm movements. This invention has the following advantages: accurate, easy to operate, time saving, economical, convenient, and multifunctional.

### PRIORITY FILING DATE

Applicant claims priority date of Dec. 15, 2009 based on Provisional Application No. 61/286,777.

### BACKGROUND OF THE INVENTION

1. Field of the Invention

The present invention relates generally to tools of precision measurement, and more particularly to a digital diameter gauge with rotary motion sensor for use in combination with an outside diameter caliper, inside diameter caliper, digital diameter divider, and digital compass, and method for use which accurately and precisely measures either the inside or outside diameter of an object. The invention measures any combination of the above. This invention allows a user to make measurements much faster as compared with a wide variety of outside calipers that are on the market today.

The conventional inside calipers or outside calipers on the market today utilize a sliding measurements ruler system whereby the measurement is calculated using rudimentary eyeball methods. Due to the design of the conventional inside calipers or outside calipers on the market today, it is not easy to take quick and accurate measurements, and therefore, the measuring efficiency has been low.

2. Brief Description of the Related Art

The field of measurements and specifically to measurement calipers as used by such persons as drafters, contractors, artisans, architects machinists, etc. are used on a daily basis. Tools for providing accurate measurements of outside lengths, widths, diameters, and heights are absolutely necessary for the completion of jobs in these industries.

Contractors, machinists and architects however, must carry a large amount of other tools and supplies with them during jobs to perform necessary tasks. Any of these persons would be enabled to perform their duties more efficiently if measurements are done more rapidly with increased accuracy, thereby lessening fatigue and thereby increasing work quality.

The present invention relates to measuring gauges that measures the inside or outside diameter, diameter divider and compass, etc. Mechanical Inside and outside calipers diameter divider and compass on the market today do not have digital display and even do not have mechanical reading scale, they usually encounter the following problems: difficult to operate, time consuming, and are therefore not accurate. Depending on the position of the object, sometimes, it is even difficult to conduct the measurements.

For a conventional mechanical inside and outside diameter caliper, diameter divider and compass, it cannot make a direct reading. Also, the accuracy is limited since it requires repeat measuring and re-measuring using a standard rule. It also takes a lot of time to make the measurement and it is very complicated. For a conventional divider or compass, if a user wants to know the length of the diameter that they are measuring, it also needs additional tools like rulers and being read on a sliding scale measurement. It was very inconvenient, and not accurate.

With this present invention, measuring a diameter of an object can become effortless. This invention has the following advantages: easy to operate, accurate, time saving, economical, convenient, and multifunctional. The accuracy of this present invention can be improved to 0.01 inch accuracy. And, it only uses less than half of the time to conduct any measurement as compared with the conventional measuring gauges. With different set of measuring arms attached, it can be use as a digital inside diameter caliper, digital outside diameter caliper, digital diameter divider, or digital compass.

### SUMMARY OF THE INVENTION

The present invention relates generally to tools of precision measurement, and more particularly the present invention relates to a measuring gauge that measures the inside or outside diameter, diameter divider and compass. Mechanical Inside and outside calipers, diameter dividers and compasses currently on the market today do not have digital display and even do not have mechanical reading scale, and they usually having the following problems: difficult to operate, time consuming, and are not accurate in providing measurements. Depending on the position of the object, sometimes, it is even difficult to conduct the measurements of the work.

For a conventional mechanical inside and outside diameter caliper, diameter dividers and compasses, cannot make a direct reading. Also, the accuracy is limited since it requires repeat measuring and re-measuring using a rule. This type of complicated measurement necessitates additional time and effort to make the measurements. For a conventional divider or compass, if a user wants to know the diameter that they are measuring, additional tools involving a ruler would be required thereby requiring measurements that are very inconvenient, and not accurate.

Conventional digital internal and external gages existing on the market today incorporate linear motion sensors wherein the measuring range is only between zero (0) and 15 (15), or the measuring range is set between zero (0) and twenty (20) millimeters. The small measuring range is limited by the linear motion sensor, as shown and described in FIG. 5.

With this present invention, measuring a diameter of an object can become effortless. This invention has the following advantages: easy to operate, accurate, time saving, economical, convenient, and multifunctional. The accuracy of this present invention can be improved to 0.01 inch. And, it requires only less than half of the time to conduct any measurement as compared with the conventional measuring gauges currently on the market today. With different sets of measuring arms attached, the present invention can be used as a digital inside diameter caliper, digital outside diameter caliper, digital diameter divider, or digital compass.

The present invention incorporates a rotary motion capacitive or inductive sensor wherein the measuring range is increased up to ten (10) times that of the conventional measuring ranges of linear motion sensor diameter gages. The measuring range of the present invention incorporates a rotary motion sensor spanning in a range between zero (0) and two-hundred (200) millimeters.

### BRIEF DESCRIPTION OF THE DRAWINGS

FIG. 1 through FIG. 4 shows detail drawing of the present invention to be used for different applications. It includes:

FIG. 1 Digital Inside Diameter Caliper

FIG. 2 Digital Outside Diameter Caliper

FIG. 3 Digital Diameter Divider

FIG. 4 Digital Compass

FIG. 5 shows a Linear Sensor Unit for comparison

FIG. 6 shows a Rotary Sensor Unit

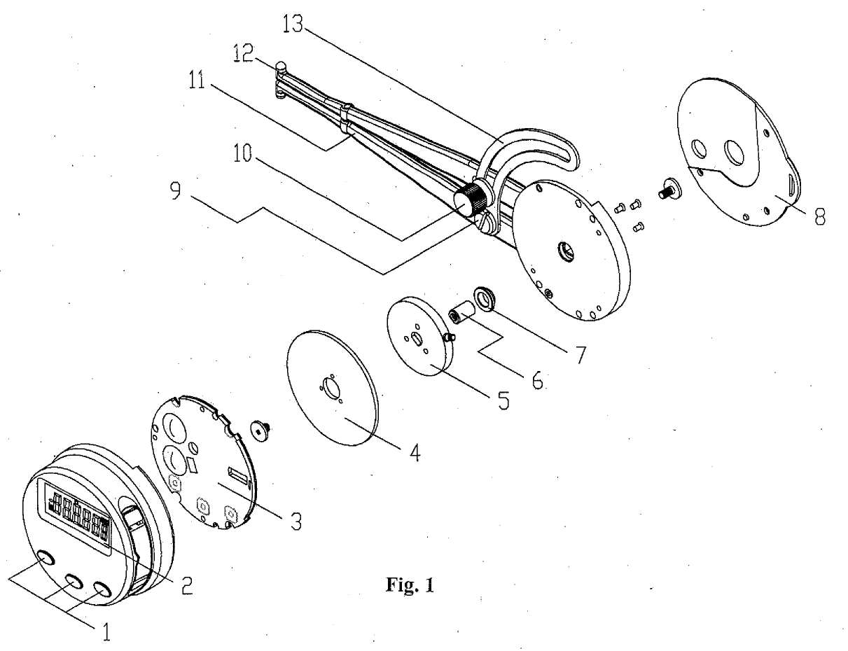

FIG. 1, shows a detailed drawing of the Digital Inside Diameter Caliper. (1) Functional buttons; (2) Digital LCD Display; (3) Second Sensor of Rotary Motion Capacitive Sensor Unit & Electronic Processor Unit Plate; (4) First Sensor of Rotary Motion Capacitive Sensor Unit; (5) First Sensor Base; (6) Rotation Bar; (7) Bar Washer; (8) Back Cover; (9) Sliding Guide Screw; (10) Locking Screw; (11) Digital Inside Diameter Caliper Arm 1; (12) Digital Inside Diameter Caliper Arm 2; (13) Sliding Guide.

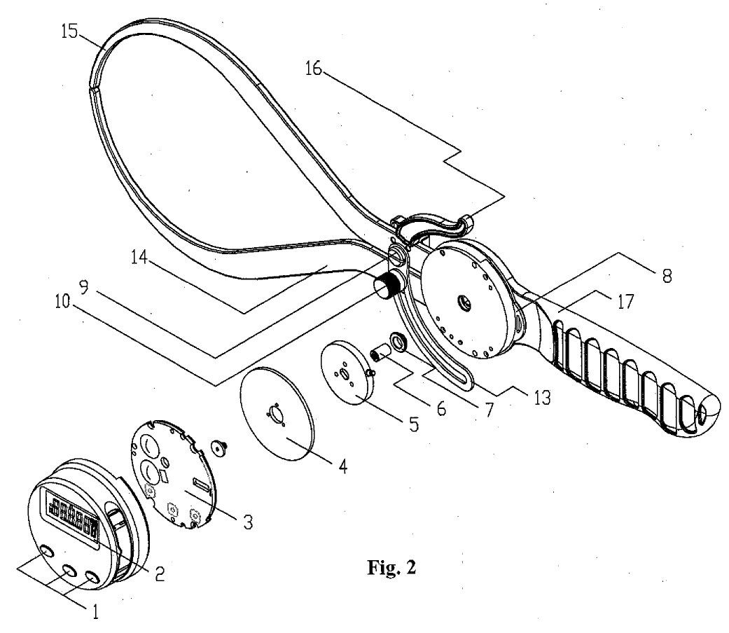

FIG. 2, shows a detailed drawing of the Digital Outside Diameter Caliper. The parts are numbered as follows: (1) Functional buttons; (2) Electronic Digital LCD Display; (3) Second Sensor of Rotary Motion Capacitive Sensor Unit and Electronic Processor Unit Plate (4) First Sensor of Rotary Motion Capacitive Sensor Unit; (5) First Sensor Base; (6) Rotation Bar; (7) Bar Washer; (8) Back Cover; (9) Sliding Guide Screw; (10) Locking Screw; (13) Sliding Guide; (14) Outside Diameter Caliper Arm 1; (15) Outside Diameter Caliper Arm 2; (16) Arm Controller; (17) Handle.

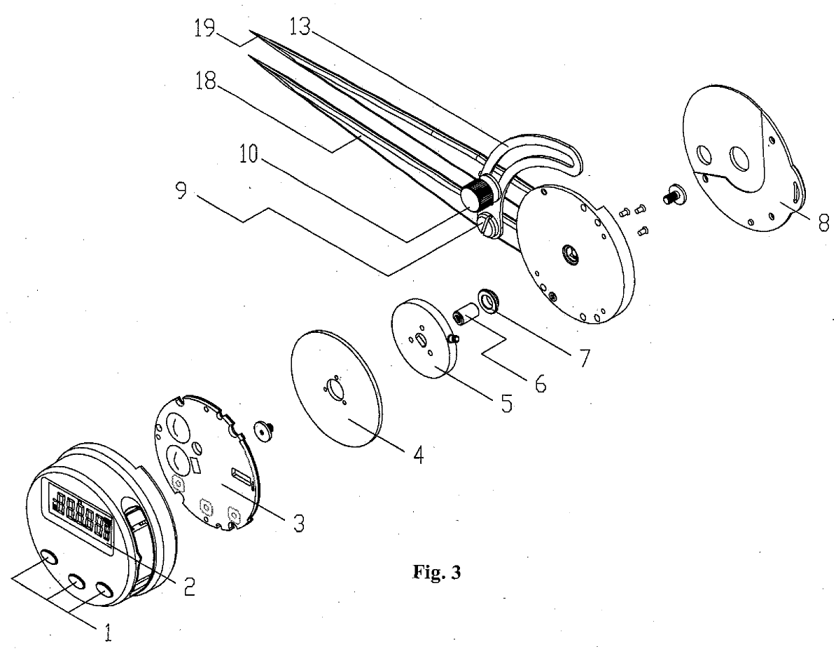

FIG. 3, shows a detailed drawing of the Digital Diameter Divider. Digital Diameter Divider incorporates: (1) Functional buttons; (2) Electronic Digital LCD Display; (3) Second Sensor of Rotary Motion Capacitive Sensor Unit and Electronic Processor Unit Plate; (4) First Sensor of Rotary Motion Capacitive Sensor Unit; (5) First Sensor Base; (6) Rotation Bar; (7) Bar Washer; (8) Back Cover; (9) Sliding Guide Screw; (10) Locking Screw; (13) Sliding Guide; (18) Digital Diameter Divider Arm 1; (19) Digital Diameter Divider Arm 2.

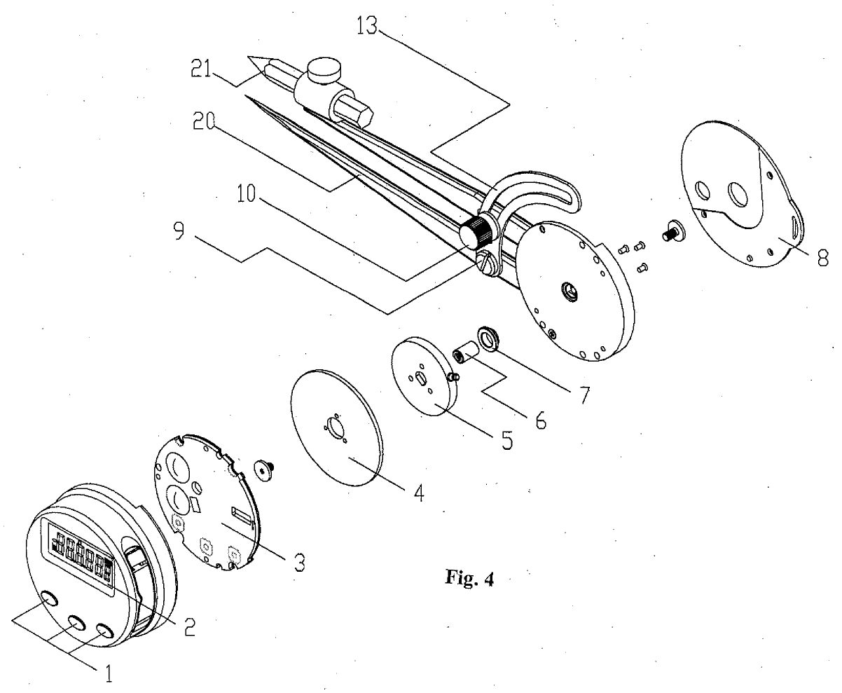

FIG. 4, shows a detailed drawing of the Digital Compass. Digital Compass incorporates: (1) Functional buttons; (2) Electronic Digital LCD Display; (3) Second Sensor of Rotary Motion Capacitive Sensor Unit and Electronic Processor Unit Plate; (4) First Sensor of Rotary Motion Capacitive Sensor Unit; (5) First Sensor Base; (6) Rotation Bar; (7) Bar Washer; (8) Back Cover; (9) Sliding Guide Screw; (10) Locking Screw; (13) Sliding Guide (20) Digital Compass Arm 1; (21) Digital Compass Arm 2 and Pencil.

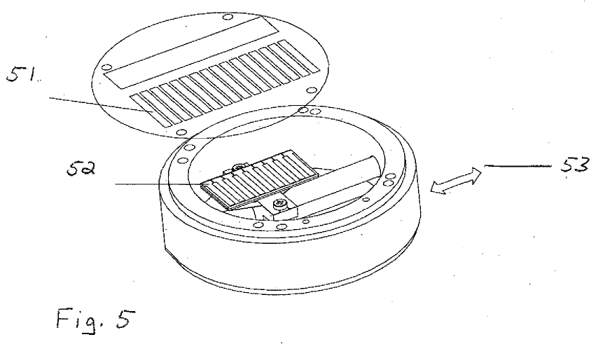

FIG. 5, shows a Linear Sensor Unit. Linear Fixed Sensor (51). Linear Motion Sensor (52). Sliding Direction (53) is indicated.

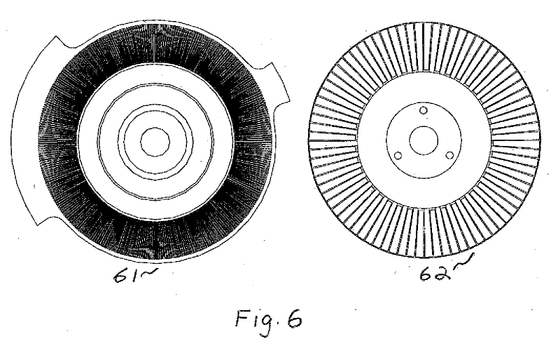

FIG. 6, shows a Rotary Sensor Unit. Rotary Fixed Sensor (61). Rotary Motion Sensor (62).

### DESCRIPTION OF PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Referring to the drawing figures, like reference numerals designate identical or corresponding elements throughout the several figures.

According to principles of the present invention, the present invention relates generally to tools of precision measurement, and more particularly to a digital diameter gauge with rotary motion sensor for use in combination with an outside diameter caliper, inside diameter caliper, digital diameter divider, and digital compass, and method for use which accurately and precisely measures either the inside or outside diameter of an object. The invention measures any combination of the above. This invention allows user to make measurement much faster as compared with a wide variety of outside calipers that are on the market today. The conventional inside calipers or outside calipers on the market today utilize a sliding measurements ruler system whereby the measurement is calculated using rudimentary eyeball methods. Due to the design of the conventional inside calipers or outside calipers on the market today, it is not easy to take quick and accurate measurements. And therefore, the measuring efficiency and accuracy has been low.

Still other objects, features, and attendant advantages of the present invention will become apparent to those skilled in the art from a reading of the following detailed description of embodiments constructed in accordance therewith, taken in conjunction with the accompanying drawings.

FIG. 1, shows a detailed drawing of the Digital Inside Diameter Caliper. (1) Functional buttons; (2) Digital LCD Display; (3) Second Sensor of Rotary Motion Capacitive Sensor Unit & Electronic Processor Unit Plate; (4) First Sensor of Rotary Motion Capacitive Sensor Unit; (5) First Sensor Base; (6) Rotation Bar; (7) Bar Washer; (8) Back Cover; (9) Sliding Guide Screw; (10) Locking Screw; (11) Digital Inside Diameter Caliper Arm 1; (12) Digital Inside Diameter Caliper Arm 2; (13) Sliding Guide.

The end of (11) Digital Inside. Diameter Caliper Arm 1 and (12) Inside Diameter Caliper Arm 2 are assembled on the inside of the (8) Back Cover. (12) Inside Diameter Caliper Arm 2 is connected to (4) First Sensor of Rotary Motion Capacitive Sensor Unit though (6) Rotation Bar, (7) Bar Washer and (5) First Sensor Base. As the (12) Inside Diameter Caliper Arm 2 moves, the movement transfers to a rotary movement by the (6) Rotation Bar and rotates the (5) First Sensor Base and (4) First Sensor of Rotary Motion Capacitive Sensor Unit to the same direction. (3) Second Sensor of Rotary Motion Capacitive Sensor Unit and the Electronic Processor Unit are mounted on the same plate as (3) Second Sensor of Rotary Motion Capacitive Sensor Unit & Electronic Processor Unit Plate. (11) Inside Diameter Caliper Arm 1 connects to (3) Second Sensor of Rotary Motion Capacitive Sensor Unit and Electronic Processor Unit Plate. (2) Electronic Digital LCD Display is mounted in front of the (8) Back Cover, which covers parts (3),(4),(5),(6),(7) inside. (9) Sliding Guide Screw secures (13) Sliding Guide on (11) Inside Diameter Caliper Arm 1. (10) Locking Screw goes though (13) Sliding Guide and is assembled on (12) Inside Diameter Caliper Arm 2. Therefore, (12) Inside Diameter Caliper Arm 2 can only travel within the range of the (13) Sliding Guide though (10) Locking Screw. Users can also use (10) locking screw to lock the movement of (12) Inside Diameter Caliper Arm 2 by tightening the screw. With the movement created by the two measuring arms, it creates a rotary movement between (4) First Sensor of Rotary Motion Capacitive Sensor Unit and (3) Second Sensor of Rotary Motion Capacitive Sensor Unit and Electronic Processor Unit Plate. Two rotary motion capacitive sensors collects and transfers the data to the Electronic Processor Unit. The Electronic Processor Unit then calculates and transfers the data into readable measuring data and thereby displays it on (2) Electronic Digital LCD Display.

FIG. 2, shows a detailed drawing of the Digital Outside Diameter Caliper. The parts are numbered as follows: (1) Functional buttons; (2) Electronic Digital LCD Display; (3) Second Sensor of Rotary Motion Capacitive Sensor Unit and Electronic Processor Unit Plate (4) First Sensor of Rotary Motion Capacitive Sensor Unit; (5) First Sensor Base; (6) Rotation Bar; (7) Bar Washer; (8) Back Cover; (9) Sliding Guide Screw; (10) Locking Screw; (13) Sliding Guide; (14) Outside Diameter Caliper Arm 1; (15) Outside Diameter Caliper Arm 2; (16) Arm Controller; (17) Handle.

The end of (14) Digital Outside Diameter Caliper Arm 1 and (15) Digital Outside Diameter Caliper Arm 2 are assembled on the inside of the (8) Back Cover. (15) Outside Diameter Measuring Caliper Arm 2 is connected to (4) First Sensor of Rotary Motion Capacitive Sensor Unit though (6) Rotation Bar, (7) Bar Washer and (5) First Sensor Base. As the (15) Digital Outside Diameter Caliper Arm 2 moves, the movement is transferred to a rotary movement by the (6) Rotation Bar and rotates the (5) First Sensor Base and (4) First Sensor of Rotary Motion Capacitive Sensor Unit to the same direction. (3) Second Sensor of Rotary Motion Capacitive Sensor Unit and the Electronic Processor Unit are mounted on the same plate as (3) Second Sensor of Rotary Motion Capacitive Sensor Unit and Electronic Processor Unit Plate. (14) Digital Outside Diameter Caliper Arm 1 connects to (3) Second Sensor of Rotary Motion Capacitive Sensor Unit and Electronic Processor Unit Plate. (2) Digital LCD Display is mounted in front of the (8) Back Cover which covers parts (3),(4),(5),(6),(7) inside. (9) Sliding Guide Screw secures (13) Sliding Guide on (14) Digital Outside Diameter Caliper Arm 1. (10) Locking Screw goes though (13) Sliding Guide and assembled on (15) Outside Diameter Measuring Caliper Arm 2. Therefore, (15) Digital Outside Diameter Caliper Arm 2 can only travel within the range of the (13) Sliding Guide though (10) Locking Screw. Users can also use (10) locking Screw to lock the movement of (15) Digital Outside Diameter Caliper Arm 2 by tightening the screw. With the movement created by the two measuring arms, it creates a rotary movement between (4) First Sensor of Rotary Motion Capacitive Sensor Unit and (3) Second Sensor of Rotary Motion Capacitive Sensor Unit and Electronic Processor Unit Plate. Two rotary motion capacitive sensors collects and transfer the data to the Electronic Processor Unit. The Electronic Processor Unit then calculates and transfers the data into readable measuring data and display it on (2) Electronic Digital LCD Display.

FIG. 3, shows a detailed drawing of the Digital Diameter Divider. Digital Diameter Divider incorporates: (1) Functional buttons; (2) Electronic Digital LCD Display; (3) Second Sensor of Rotary Motion Capacitive Sensor Unit and Electronic Processor Unit Plate; (4) First Sensor of Rotary Motion Capacitive Sensor Unit; (5) First Sensor Base; (6) Rotation Bar; (7) Bar Washer; (8) Back Cover; (9) Sliding Guide Screw; (10) Locking Screw; (13) Sliding Guide; (18) Digital Diameter Divider Arm 1; (19) Digital Diameter Divider Arm 2.

The end of (18) Digital Diameter Divider Arm 1 and (19) Digital Diameter Divider Arm 2 are assembled on the inside of the (8) Back Cover. (19) Diameter Divider Arm 2 is connected to (4) First Sensor of Rotary Motion Capacitive Sensor Unit though (6) Rotation Bar, (7) Bar Washer and (5) First Sensor Base. As the (19) Diameter Divider Arm 2 moves, the movement is transferred to a rotary movement by the (6) Rotation Bar and rotates the (5) First Sensor Base and (4) First Sensor of Rotary Motion Capacitive Sensor Unit to the same direction. (3) Second Sensor of Rotary Motion Capacitive Sensor Unit and the Electronic Processor Unit are mounted on the same plate as (3) Second Sensor of Rotary Motion Capacitive Sensor Unit and Electronic Processor Unit Plate. (18) Digital Diameter Divider Arm 1 connects to (3) Second Sensor of Rotary Motion Capacitive Sensor Unit and Electronic Processor Unit Plate. (2) Electronic Digital LCD Display is mounted in front of the (8) Back Cover which covers parts (3),(4),(5),(6),(7) inside. (9) Sliding Guide Screw secures (13) Sliding Guide on (18) Digital Diameter Divider Arm 1. (10) Locking Screw goes though (13) Sliding Guide and is assembled on (19) Digital Diameter Divider Arm 2. Therefore, (19) Digital Diameter Divider Arm 2 can only travel within the range of the (13) Sliding Guide though (10) Locking Screw. Users can also use (10) Locking Screw to lock the movement of (19) Digital Diameter Divider Arm 2 by tightening the screw. With the movement created by the two measuring arms, it creates a rotary movement between (4) First Sensor of Rotary Motion Capacitive Sensor Unit and (3) Second Sensor of Rotary Motion Capacitive Sensor Unit and Electronic Processor Unit Plate. Two rotary motion capacitive sensors collects and transfers the data to the Electronic Processor Unit. The Electronic Processor Unit then calculates and transfers the data into readable measuring data and displays it on (2) Electronic Digital LCD Display.

FIG. 4, shows a detailed drawing of the Digital Compass. Digital Compass incorporates: (1) Functional buttons; (2) Electronic Digital LCD Display; (3) Second Sensor of Rotary Motion Capacitive Sensor Unit and Electronic Processor Unit Plate; (4) First Sensor of Rotary Motion Capacitive Sensor Unit; (5) First Sensor Base; (6) Rotation Bar; (7) Bar Washer; (8) Back Cover; (9) Sliding Guide Screw; (10) Locking Screw; (13) Sliding Guide (20) Digital Compass Arm 1; (21) Digital Compass Arm 2 and Pencil.

The end of (20) Digital Compass Arm 1 and (21) Digital Compass Arm 2 are assembled on the inside of the (8) Back Cover; (21) Digital Compass Arm 2 is connected to (4) First Sensor of Rotary Motion Capacitive Sensor Unit though (6) Rotation Bar; (7) Bar Washer and (5) First Sensor Base. As the (21) Digital Compass Arm 2 moves, the movement is transferred to a rotary movement by the (6) Rotation Bar and rotates the (5) First Sensor Base and (4) First Sensor of Rotary Motion Capacitive Sensor Unit to the same direction. (3) Second Sensor of Rotary Motion Capacitive Sensor Unit and the Electronic Processor Unit are mounted on the same plate as (3) Second Sensor of Rotary Motion Capacitive Sensor Unit and Electronic Processor Unit Plate. (20) Digital Compass Arm 1 connects to (3) Second Sensor of Rotary Motion Capacitive Sensor Unit and Electronic Processor Unit Plate. (2) Electronic Digital LCD Display is mounted in front of the (8) Back Cover which covers parts (3),(4),(5),(6),(7) inside. (9) Sliding Guide Screw secures (13) Sliding Guide on (20) Digital Compass Arm 1. (10) Locking. Screw goes though (13) Sliding Guide and is assembled on (21) Digital Compass Arm 2. Therefore, (21) Digital Compass Arm 2 can only travel within the range of the (13) Sliding Guide though (10) Locking Screw. Users can also use (10) Locking Screw to lock the movement of (21) Digital Compass Arm 2 by tightening the screw. With the movement created by the two measuring arms, it creates a rotary movement between (4) First Sensor of Rotary Motion Capacitive Sensor Unit and (3) Second Sensor of Rotary Motion Capacitive Sensor Unit and Electronic Processor Unit Plate. Two rotary motion capacitive sensors collects and transfers the data to the Electronic Processor Unit. The Electronic Processor Unit then calculates and transfers the data into readable measuring data and displays it on the (2) Electronic Digital LCD Display.

FIG. 5, shows a Linear Sensor Unit. Linear Fixed Sensor (51). Linear Motion Sensor (52). Sliding Direction (53) is indicated.

FIG. 6, shows a Rotary Sensor Unit. First Sensor of Rotary Motion Sensor (61). Second Sensor of Rotary Motion Sensor (62).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention described by the foregoing includes all changes that come within the meaning, range and equivalence thereof and is intended to be embraced therein.

1. A range measuring digital gauge comprising a rotary motion sensor comprising two measuring arms (Arm 1 and Arm 2), a rotary motion capacitive sensor unit, which include a first rotary motion sensor and a second rotary motion sensor, an electronic processor unit, and an electronic digital display unit; wherein said first sensor is mounted on Arm 1, and said second sensor is mounted on Arm 2; wherein said arm 1 and said arm 2 rotably move, thereby causing data to be created by said rotary motion capacitive sensor unit whereby said data is transferred to said electronic processor unit; wherein said electronic processor unit computes said data into readable data thereby displaying it onto said electronic digital display unit, whereby an apparatus for measuring ranges is provided.

2. The invention of claim 1 wherein said electronic processor unit is mounted on an electronic processor plate, wherein said electronic processor plate is fixed on a proximal end of arm 1 of said measuring arms.

3. The invention of claim 2, further comprising a display cover coupled to said electronic digital display unit, wherein said electronic digital display unit is mounted inside said display cover, wherein said display cover is assembled on proximal end of arm 2 of said measuring arms.

4. The invention of claim 3 further comprising an arm controller and a handle, wherein said arm controller is assembled on measuring arm 1, and wherein said handle is assembled on said measuring arm 2.

5. The invention of claim 4, further comprising a sliding guide plate and a guide screw, wherein said sliding guide is slidably coupled to said guide screw and wherein said sliding guide and said guide screw is assembled on said measuring arm 1, wherein a locking screw is assembled onto said measuring arm 2, wherein said locking screw is slidably fitted within said sliding guide, whereby a maximum distance between distal ends of said measuring arm 1 and said measuring arm 2 travel is limited to a predetermined range of travel as determined by said sliding guide, whereby said locking screw is screw tightened to lock said measuring arm 1 and said measuring arm 2 at any position within the sliding guide travel range.

6. The invention of claim 5, wherein said measuring arm 1 and said measuring arm 2 jointly form an inside diameter caliper.

7. The invention of claim 5, wherein said measuring arm 1 and said measuring arm 2 jointly form an outside diameter caliper.

8. The invention of claim 5, wherein said measuring arm 1 and said measuring arm 2 jointly form a diameter divider.

9. The invention of claim 5, wherein said measuring arm 1 and said measuring arm 2 jointly form a compass.
